(19) United States
(12) Patent Application Publication
(10) Pub. No.: US 2024/0063465 A1
(43) Pub. Date: Feb. 22, 2024

(54) COLD-PLATE DESIGN FOR THERMAL RUNAWAY MITIGATION IN A BATTERY MODULE

(71) Applicant: GM GLOBAL TECHNOLOGY OPERATIONS LLC, Detroit, MI (US)

(72) Inventor: Justin D. Benden, College Station, TX (US)

(73) Assignee: GM GLOBAL TECHNOLOGY OPERATIONS LLC, Detroit, MI (US)

(21) Appl. No.: 17/891,374

(22) Filed: Aug. 19, 2022

(51) Int. Cl. H01M 10/6554; H01M 50/213; H01M 50/249; H01M 50/375; H01M 10/613; H01M 10/625; H01M 10/6556; H01M 10/643; B60L 50/64; B60L 58/24

(52) U.S. Cl. CPC H01M 10/6554; H01M 50/213; H01M 50/249; H01M 50/375; H01M 10/613; H01M 10/625; H01M 10/6556; H01M 10/643; B60L 50/64; B60L 58/24; H01M 2220/20; H01M 2200/10

(57) ABSTRACT

A battery module includes first and second neighboring battery cells. The battery module also includes a cold-plate configured to remove thermal energy from the first and second battery cells. The cold-plate includes first and second sections configured to seat respective first and second cells. The first section defines a first vent arranged directly adjacent the first cell and configured to exhaust gases therefrom. The cold-plate additionally includes a first closure element arranged within and configured to block the first vent in a first mode to transfer thermal energy from the first cell to the cold-plate. The first closure element is additionally configured to open the first vent in a second mode when the first cell undergoes a thermal event to exhaust gases and transfer thermal energy from the first cell through the first vent and thereby control propagation of a thermal runaway in the battery module.

### INTRODUCTION

The present disclosure relates to a cold-plate design for thermal runaway mitigation in a battery module

A battery module or array may include a plurality of battery cells in relatively close proximity to one another. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Such chemical reactions may cause more heat to be generated by the batteries than is effectively withdrawn. Exposure of a battery cell to elevated temperatures over prolonged periods may cause the cell to experience a thermal runaway event. Accordingly, a thermal runaway event starting within an individual cell may lead to the heat spreading to adjacent cells in the module and cause the thermal runaway event to affect the entire battery array.

### SUMMARY

A battery module includes a first battery cell and a neighboring second battery cell. The battery module also includes a cold-plate in contact with each of the first battery cell and the second battery cell and configured to remove thermal energy from the first and second battery cells. The cold-plate includes a first section configured to seat the first battery cell and defining a first vent arranged directly adjacent the first battery cell and configured to exhaust gases from the first battery cell. The cold-plate also includes a second section configured to seat the second battery. The cold-plate additionally includes a first closure element arranged within the first vent and configured to block the first vent in a first mode and transfer thermal energy from the first battery cell to the cold-plate. The first closure element is additionally configured to open the first vent in a second mode when the first battery cell undergoes a thermal event to thereby exhaust the gases from the first battery cell and transfer thermal energy from the first battery cell through the first vent and away from the second battery cell. As a result, in the second mode, the first closure element is configured to control propagation of a thermal runaway in the battery module.

The first closure element may include a first layer and a second layer. The first layer may be constructed from a relatively low-thermal conductivity material. The second layer may be constructed from a relatively high-thermal conductivity material and arranged between the first layer and the first battery cell.

The relatively low-thermal conductivity material may be a silicon-based (silicone or silicon-oxygen) polymer.

The relatively high-thermal conductivity material may be a urethane-based polymer.

The cold-plate may include a first surface adjacent the first and second battery cells and an opposing second surface. The first section may include a fin extending from the first surface, surrounding the first vent, and configured to position and hold the first battery cell and generate a heat transfer path from the first battery cell to the cold-plate.

Each of the first and second battery cells may be configured as a cylindrical cell. In such an embodiment, the fin may include a first fin portion and a second fin portion. Together, the first and second fin portion define a circular pocket configured to house the cylindrical first battery cell.

The cold-plate may be a coolant plate having coolant channels arranged between the first and second vents.

A motor vehicle having a power-source and the above-disclosed battery module configured to supply electric energy to the power-source is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a battery module having a plurality of battery cells configured to generate and store electrical energy, according to the disclosure.

FIG. 2 is a schematic cross-sectional plan view of the battery module shown in FIG. 1, having a cold-plate, a battery module enclosure, and a general representation of closure elements arranged within respective vents and configured to mitigate thermal runaway in the battery module, according to the disclosure.

FIG. 3 is a schematic close-up cross-sectional partial plan view of the cold-plate shown in FIG. 2 and the closure elements arranged within respective vents.

FIG. 4 is a schematic top view of the cold-plate shown in FIG. 2, specifically depicting the cold-plate configured as a coolant plate having a fluid inlet and a fluid outlet, each fluidly connected to internal coolant channels arranged to provide coolant flow in series with respect to the battery cells, according to the disclosure.

FIG. 5 is a schematic top view of the cold-plate shown in FIG. 2, specifically depicting the cold-plate configured as a coolant plate having a fluid inlet and a fluid outlet, each fluidly connected to internal coolant channels arranged to provide coolant flow in parallel with respect to the battery cells, according to the disclosure.

FIG. 6 is a schematic close-up cross-sectional partial plan view of the battery module shown in FIG. 2, depicting operation of the closure elements when one of the battery cells experiences a thermal event, according to the disclosure.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

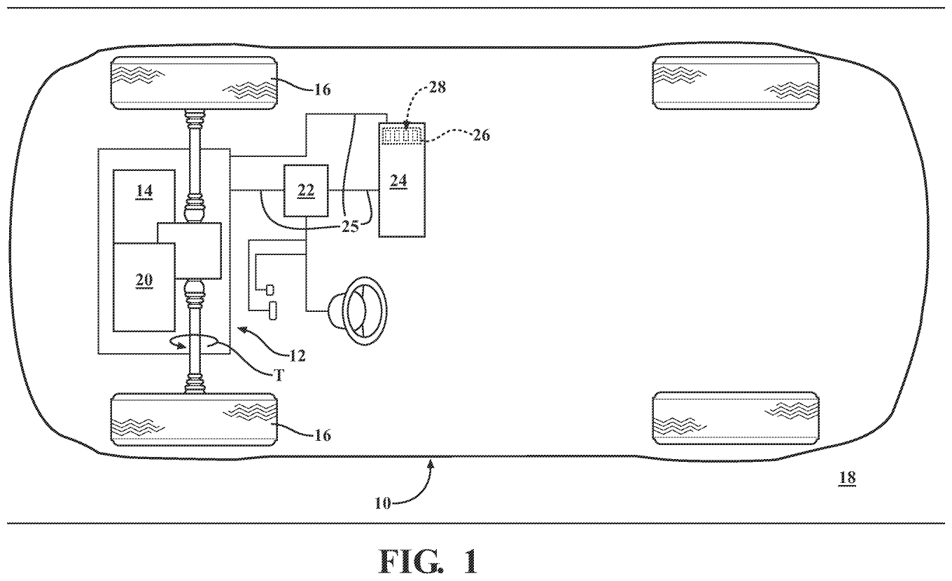

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may also include an additional power-source 20, such as an internal combustion engine. The power-sources 14 and 20 may act in concert to power the vehicle 10. The vehicle 10 additionally includes an electronic controller 22 and a battery system 24 configured to generate and store electrical energy through heat-producing electro-chemical reactions for supplying the electrical energy to the power-sources 14 and 20. The electronic controller 22 may be a central processing unit (CPU) that regulates various functions on the vehicle 10, or as a powertrain control module (PCM) configured to control the powertrain 12 to generate a predetermined amount of power-source torque T. The battery system 24 may be connected to the power-sources 14 and 20, the electronic controller 22, as well as other vehicle systems via a high-voltage BUS 25. The battery system 24 may include one or more sections, such as a battery array or module 26.

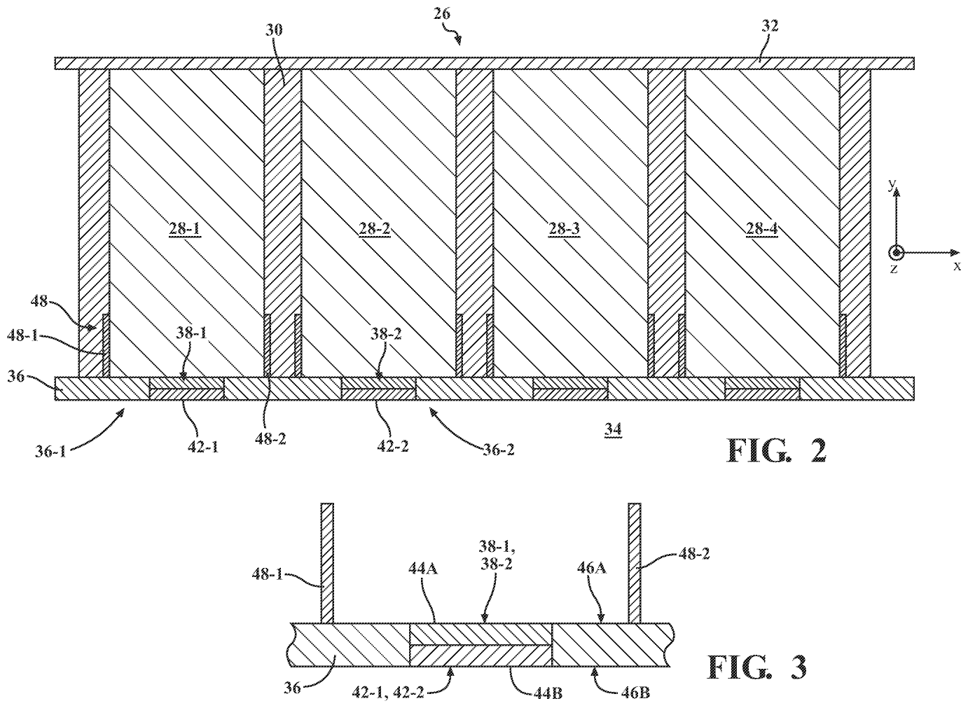

As shown in FIG. 2, each battery module 26 includes a plurality of battery cells, such as a first battery cell 28-1 and a neighboring, directly adjacent, second battery cell 28-2, as well as third and fourth battery cells 28-3 and 28-4. As shown, each of the battery cells 28-1, 28-2, 28-3, 28-4 may be configured as a cylindrical cell, extending generally upward in an X-Y plane. Although one module 26 and four battery cells 28-1, 28-2, 28-3, 28-4 are shown, nothing precludes the battery system 24 from having a greater number of modules and fewer or greater number of such battery cells. The remainder of the present description will focus on module construction having first and second battery cells 28-1, 28-2, which may be adapted to a specific battery module having a desired quantity of cells.

With continued reference to FIG. 2, the battery module 26 may also include an insulating member or pad 30 arranged between the first battery cell 28-1 and the second battery cell 28-2 (as well as between second and third, and third and fourth battery cells 28-2, 28-3, 28-4). The insulating member 30 may be constructed from a high-temperature polymer foam configured to limit the amount of thermal energy transfer between the neighboring battery cells, such as battery cells 28-1 and 28-2. The insulating member 30 is also configured to maintain consistent and uniform contact with the neighboring battery cells, such as the first cell 28-1 and the second cell 28-2 during alternate expansion of the subject cells when charging and contraction of the cells when discharging. The battery module 26 also includes a battery module enclosure 32 surrounded by an ambient environment 34 and configured to house each of the first battery cell 28-1, the second battery cell 28-2, and the insulating member 30. The enclosure 32 may be configured to protect adjacent battery cell groups from hot gases and particles during a thermal runaway event (discussed in detail below).

The battery module 26 also includes a cold-plate 36 operating as a heat sink for the battery cells 28-1, 28-2 (as well as for third and fourth battery cells 28-3 and 28-4). The cold-plate 36 is in contact with each of the first and second battery cells 28-1, 28-2 and configured to absorb and remove thermal energy therefrom. The cold-plate 36 includes a first section 36-1 configured to seat the first battery cell 28-1, i.e., arrange and maintain position thereof. The first section 36-1 defines a first vent or aperture 38-1 arranged directly adjacent the first battery cell 28-1 and configured to exhaust gases resulting from chemical reactions within the first battery cell. The cold-plate 36 also includes a second section 36-2 configured to seat the second battery cell 28-2. The second section 36-2 defines a second vent 38-2 arranged directly adjacent the second battery cell 28-2 and configured to exhaust gases therefrom.

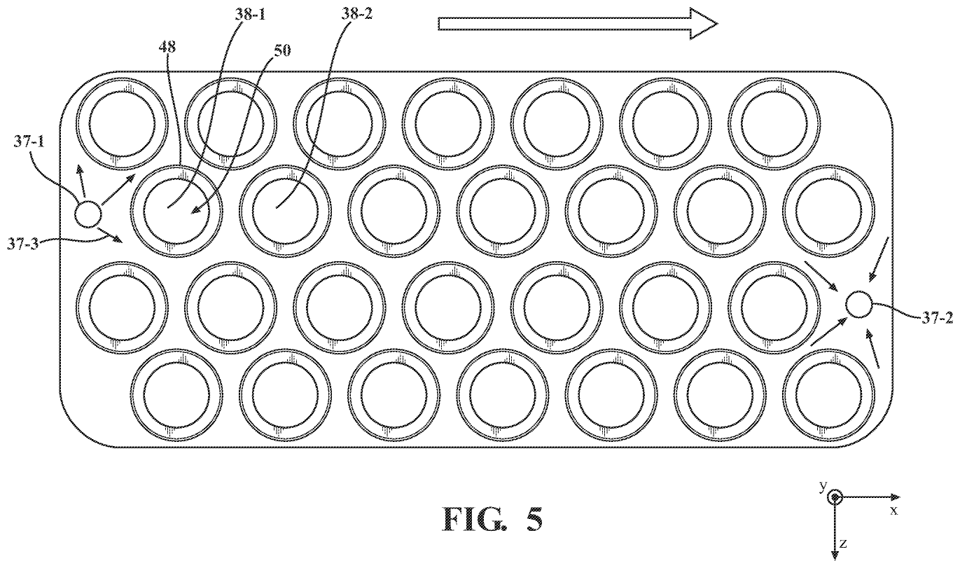

As shown in FIG. 4, the cold-plate 36 may be a coolant plate having a fluid inlet 37-1, a fluid outlet 37-2, each fluidly connected to internal coolant channels 37-3. The coolant channels 37-3 are arranged between and extending around the first and second vents 38-1, 38-2 to remove thermal energy from the first and second battery cells 28-1, 28-2 (as well as around respective vents corresponding to third and fourth battery cells 28-3, 28-4 to remove thermal energy therefrom). The cold-plate 36 may be configured to route coolant flow either in series (shown in FIG. 4) or in parallel (shown in FIG. 5) with respect to the battery module's battery cells 28-1, 28-2, 28-3, 28-4, etc. The subject coolant flow may be provided via an external fluid source, such as a fluid pump (not shown).

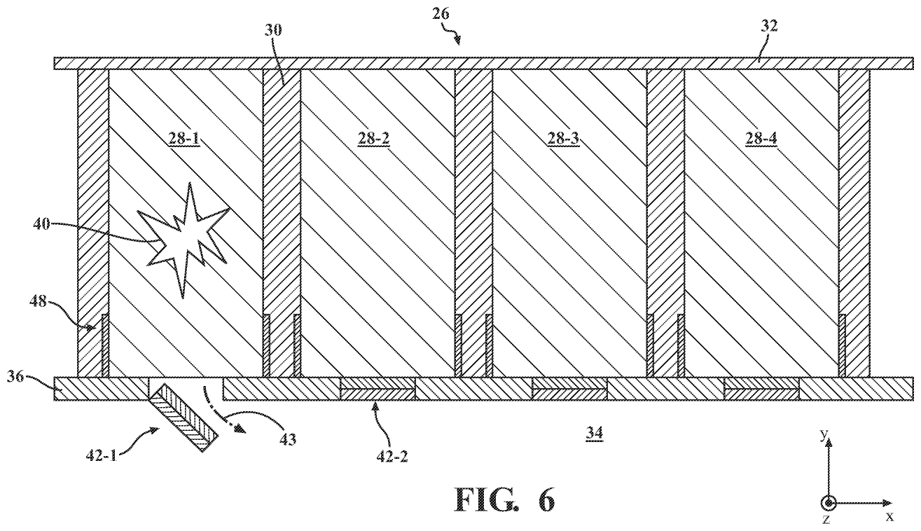

Generally, during typical charge/discharge operation of the module 26, the insulating member 30 and the cold-plate 36 are effective in absorbing thermal energy released by the first and second cells 28-1, 28-2 and facilitating transfer of the thermal energy through the cold-plate 36 to the ambient environment 34. However, during extreme conditions, such as during a thermal runaway event (identified via numeral 40 in FIG. 6), the amount of thermal energy released by the cell undergoing the event will typically saturate the insulating member 30 and exceed its capacity to absorb and efficiently transfer heat to the heat sink 36. As a result, excess thermal energy will typically be transferred between the neighboring cells 28-1, 28-2, leading to propagation of the thermal runaway through the module 26. The term “thermal runaway event” generally refers to an uncontrolled increase in temperature in a battery system. During a thermal runaway event, the generation of heat within a battery system or a battery cell exceeds the dissipation of heat, thus leading to a further increase in temperature. A thermal runaway event may be triggered by various conditions, including a short circuit within the cell, improper cell use, physical abuse, manufacturing defects, or exposure of the cell to extreme external temperatures.

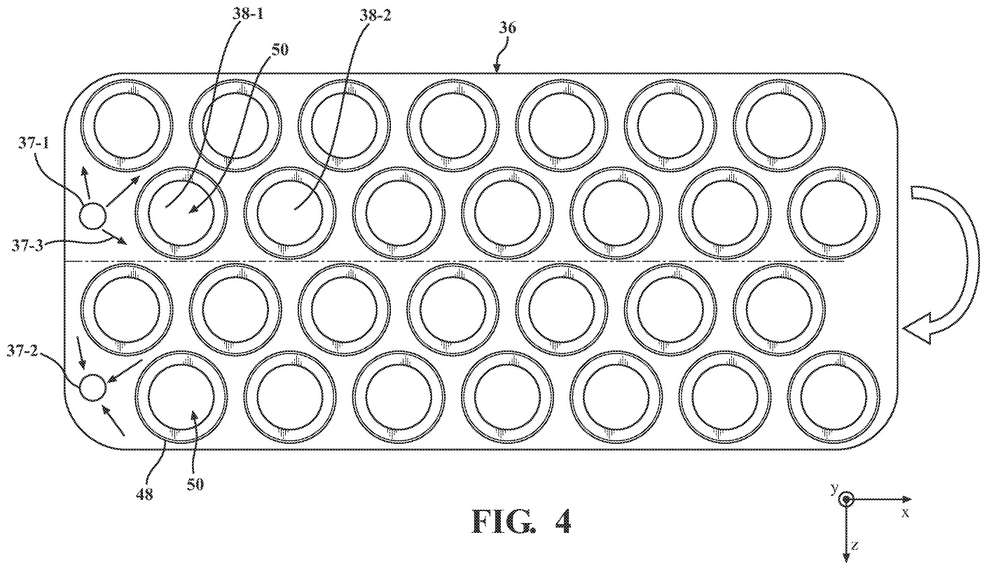

As shown in FIGS. 2 and 3, the cold-plate 36 also includes a first potting or closure element 42-1 arranged within the first vent 38-1. Additionally, the cold-plate 36 includes a second closure element 42-2 arranged within the second vent 38-2. When the thermal runaway event affects the first battery cell 28-1 or second battery cell 28-2, the respective first or second closure element 42-1, 42-2 will be ejected from the corresponding first or second vent 38-1, 38-2. Specifically, the first closure element 42-1 is configured to block the first vent 38-1 in a first mode of its operation (shown in FIG. 2) to thereby transfer thermal energy from the first battery cell to the cold-plate 36. The first closure element 42-1 is also configured to open the first vent 38-1 in a second mode of its operation (shown in FIG. 6), when the first battery cell 28-1 undergoes a thermal event to exhaust the gases from the first battery cell. Such opening of the first vent 38-1 via the first closure element 42-1 operates to transfer thermal energy, chemical gases, and debris 43 (shown in FIG. 6) from the first battery cell 28-1 through the first vent and away from the second battery cell 28-2 in a second mode. As a result, in the second mode, the opening of the first vent 38-1 via the first closure element 42-1 controls propagation of a thermal runaway in the battery module 26.

Operation of the second closure element 42-2 is analogous to that of the first closure element 42-1. Specifically, the second closure element 42-2 is configured to block the second vent 38-2 and transfer thermal energy from the second battery cell 28-2 to the cold-plate 36 in its first mode of operation. Also, the second closure element 42-2 is configured to open the second vent 38-2 in its second mode of operation if or when the second battery cell 28-2 undergoes a thermal event. Accordingly, in its second mode, the second closure element 42-2 operates to exhaust gases from the second battery cell 28-2 and transfer the second battery cell's thermal energy through the second vent 38-2 and away from the first battery cell 28-1.

With reference to FIG. 3, each of the first and second closure elements 42-1, 42-2 may include respective first layer 44A and a second layer 44B. The first layer 44A is arranged adjacent to the respective first or second battery cell 28-1, 28-2 and is constructed from a thermally resistive material. A relatively low-thermal conductivity material of the first layer 44A is specifically configured to protect the respective battery cells 28-1, 28-2 during a thermal runaway event. On the other hand, the second layer 44B is arranged closer to the ambient environment 34 and is constructed from a thermally resistive material. A relatively high-thermal conductivity material of the second layer 44B is specifically configured to promote battery cell to cold-plate 36 heat transfer. As shown in FIG. 3, the second layer 44B is arranged between the first layer 44A and the respective first battery cell 28-1 or second battery cell 28-2. The relatively low-thermal conductivity material of the first layer 44A may be a silicon-based polymer. The relatively high-thermal conductivity material of the second layer 44B may be a urethane-based polymer.

As may be seen in FIG. 3, the cold-plate 36 includes a first surface 46A adjacent the first and second battery cells 28-1, 28-2 and an opposing second surface 46B. Each of the first and second sections 36-1, 36-2 of the cold-plate 36 may include a fin 48 extending from the first surface 46A and surrounding the first vent 38-1. The respective fins 48 are configured to position and hold the first battery cell 28-1 and the second battery cell 28-2 relative to each other and with respect to the cold-plate 36. Each fin 48 is also configured to generate a heat transfer path from the respective first or second battery cells 28-1, 28-2 to the cold-plate 36. In a particular embodiment shown in FIGS. 4 and 5, each fin 48 may be configured as an annular sleeve defining a respective circular pocket 50 (in an X-Z plane) configured to house the respective cylindrical first or second battery cell 28-1, 28-2. Alternatively, as shown in FIGS. 2 and 3, each fin 48 may include a first fin portion 48-1 and a second fin portion 48-2. Together, the first and second fin portions 48-1, 48-2 of each fin 48 may define the circular pocket 50 (in the X-Z plane) housing the respective cylindrical first or second battery cell 28-1, 28-2.

Overall, the cold-plate 36 uses the closure elements, such as first and second closure elements 42-1, 42-2, to transfer thermal energy away from the battery module's battery cells, such as the first and second battery cells 28-1, 28-2, during normal operation of the battery module 26. Furthermore, the subject closure elements are employed to open the respective vents, e.g., first and second vents 38-1, 38-2, in the cold-plate 36 when one of the module's battery cells undergoes a thermal event to exhaust the battery cell gases to the ambient environment 34. By transferring the thermal energy through the opened subject vent, the closure elements, e.g., first and second closure elements 42-1, 42-2, control propagation of thermal runaway in the battery module 26.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A battery module comprising:
a first battery cell and a neighboring second battery cell; and
a cold-plate in contact with each of the first battery cell and the second battery cell and configured to remove thermal energy from the first and second battery cells;
wherein the cold-plate includes:
a first section configured to seat the first battery cell and defining a first vent arranged directly adjacent the first battery cell and configured to exhaust gases from the first battery cell;
a second section configured to seat the second battery; and
a first closure element arranged within the first vent and configured to:
block the first vent to transfer thermal energy from the first battery cell to the cold-plate in a first mode; and
open the first vent when the first battery cell undergoes a thermal event to exhaust the gases from the first battery cell and transfer thermal energy from the first battery cell through the first vent and away from the second battery cell in a second mode to control propagation of a thermal runaway in the battery module.

2. The battery module of claim 1, wherein:
the first closure element includes a first layer and a second layer;
the first layer is constructed from a relatively low-thermal conductivity material; and
the second layer is constructed from a relatively high-thermal conductivity material and arranged between the first layer and the first battery cell.

3. The battery module of claim 2, wherein the relatively low-thermal conductivity material is a silicon-based polymer.

4. The battery module of claim 2, wherein the relatively high-thermal conductivity material is a urethane-based polymer.

5. The battery module of claim 1, wherein the cold-plate includes a first surface adjacent the first and second battery cells and an opposing second surface, and wherein the first section includes a fin extending from the first surface, surrounding the first vent, and configured to position and hold the first battery cell and generate a heat transfer path from the first battery cell to the cold-plate.

6. The battery module of claim 5, wherein each of the first and second battery cells is configured as a cylindrical cell, and wherein the fin includes a first fin portion and a second fin portion, together defining a circular pocket configured to house the cylindrical first battery cell.

7. The battery module of claim 1, wherein the cold-plate is a coolant plate having coolant channels arranged between the first and second vents.

8. A motor vehicle comprising:
a power-source configured to generate power-source torque; and
a battery module configured to supply electrical energy to the power-source, the battery module including:
a first battery cell and a neighboring second battery cell; and
a cold-plate in contact with each of the first battery cell and the second battery cell and configured to remove thermal energy from the first and second battery cells;
wherein the cold-plate includes:
a first section configured to seat the first battery cell and defining a first vent arranged directly adjacent the first battery cell and configured to exhaust gases from the first battery cell;
a second section configured to seat the second battery; and
a first closure element arranged within the first vent and configured to:
block the first vent to transfer thermal energy from the first battery cell to the cold-plate in a first mode; and
open the first vent when the first battery cell undergoes a thermal event to exhaust the gases from the first battery cell and transfer thermal energy from the first battery cell through the first vent and away from the second battery cell in a second mode to control propagation of a thermal runaway in the battery module.

9. The motor vehicle of claim 8, wherein:
the first closure element includes a first layer and a second layer;
the first layer is constructed from a relatively low-thermal conductivity material; and
the second layer is constructed from a relatively high-thermal conductivity material and arranged between the first layer and the first battery cell.

10. The motor vehicle of claim 9, wherein the relatively low-thermal conductivity material is a silicon-based polymer.

11. The motor vehicle of claim 9, wherein the relatively high-thermal conductivity material is a urethane-based polymer.

12. The motor vehicle of claim 8, wherein the cold-plate includes a first surface adjacent the first and second battery cells and an opposing second surface, and wherein the first section includes a fin extending from the first surface, surrounding the first vent, and configured to position and hold the first battery cell and generate a heat transfer path from the first battery cell to the cold-plate.

13. The motor vehicle of claim 12, wherein each of the first and second battery cells is configured as a cylindrical cell, and wherein the fin includes a first fin portion and a second fin portion, together defining a circular pocket configured to house the cylindrical first battery cell.

14. The motor vehicle of claim 8, wherein the cold-plate is a coolant plate having coolant channels arranged between the first and second vents.

15. A battery module comprising:
a first battery cell and a neighboring second battery cell; and
a cold-plate in contact with each of the first battery cell and the second battery cell and configured to remove thermal energy from the first and second battery cells;
wherein the cold-plate includes:
a first section configured to seat the first battery cell and defining a first vent arranged directly adjacent the first battery cell and configured to exhaust gases from the first battery cell;
a second section configured to seat the second battery;
a first closure element arranged within the first vent and configured to:
block the first vent to transfer thermal energy from the first battery cell to the cold-plate in a first mode; and
open the first vent when the first battery cell undergoes a thermal event to exhaust the gases from the first battery cell and transfer thermal energy from the first battery cell through the first vent and away from the second battery cell in a second mode to control propagation of a thermal runaway in the battery module;
wherein:
the first closure element includes a first layer and a second layer;
the first layer is constructed from a relatively low-thermal conductivity material; and
the second layer is constructed from a relatively high-thermal conductivity material and arranged between the first layer and the first battery cell.

16. The battery module of claim 15, wherein the relatively low-thermal conductivity material is a silicon-based polymer.

17. The battery module of claim 15, wherein the relatively high-thermal conductivity material is a urethane-based polymer.

18. The battery module of claim 15, wherein the cold-plate includes a first surface adjacent the first and second battery cells and an opposing second surface, and wherein the first section includes a fin extending from the first surface, surrounding the first vent, and configured to position and hold the first battery cell and generate a heat transfer path from the first battery cell to the cold-plate.

19. The battery module of claim 18, wherein each of the first and second battery cells is configured as a cylindrical cell, and wherein the fin includes a first fin portion and a second fin portion, together defining a circular pocket configured to house the cylindrical first battery cell.

20. The battery module of claim 15, wherein the cold-plate is a coolant plate having coolant channels arranged between the first and second vents.
